(19) United States
(12) Patent Application Publication
(10) Pub. No.: US 2010/0220564 A1
(43) Pub. Date: Sep. 2, 2010

(54) DISC-DRIVE APPARATUS AND METHOD

(75) Inventor: Justin Francois Paul-Marie Frints, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/993,271

(22) PCT Filed: Jun. 26, 2006
(86) PCT No.: PCT/IB06/52096

§ 371 Date: Dec. 20, 2007

(30) Foreign Application Priority Data
Jun. 29, 2005 (EP) 05105793.3

(51) Int. Cl. G11B 17/02

(52) U.S. Cl. 369/47.4; G9B/17.002

(57) ABSTRACT

A disc drive (1) comprises first clamping means (5) and second clamping means (7) for supporting an optical disc (3) that is to be played in the disc drive (1). Drive means (9) is provided for rotating the optical disc (3) relative to optical means (11) for writing data to, or reading data from, the optical disc (3). The disc drive (1) further comprises a data storage medium (13) for storing data such as embedded software for controlling the operation of the disc drive (1). The data storage medium (13) is permanently located in the disc drive (1), thereby being permanently available for controlling the operation of the disc drive (1). The data storage medium (13) is located coaxially with optical disc (3) that is to be inserted into the disc drive (1) for playback. The data storage medium (13) is also positioned such that, during playback of a normal optical disc (3), the data storage medium is located on the reverse side of the optical disc (13), i.e. the non-optical side of the optical disc (3). In one embodiment the data storage medium is radially smaller than the optical disc (3), while in another embodiment the data storage medium is radially larger than the optical disc (3).

The invention relates to a method and apparatus for providing data storage in a disc drive. In particular, the invention relates to providing the data storage in a new location within the disc drive.

A disc drive has data storage means, i.e. memory, for storing embedded software such as firmware or information for controlling the operation of the disc drive, or for storing other types of data, such as keys for copyright protection, disc parameters, executable code, or databases which are permanently needed in the disc drive. Memory tends to be expensive, thereby having the disadvantage of increasing the cost of the disc drive. This is particularly true for memory such as flash memory.

In addition, memory for storing operational code for controlling the operation of the disc drive requires space within the body of the disc drive, which can be a disadvantage in certain applications where the disc drive needs to be as small as possible.

These disadvantages relating to the storage of data are increased by the current challenges for optical disc drives caused by the proliferation of formats, which push for the embedded software to be expanded even further. The proliferation of formats relates not only to the physical format and encoding rules, but also to the so-called upper layers, such as a particular compression algorithm used.

According to a first aspect of the invention there is provided a disc drive as defined in the appended claims, whereby a data storage medium is provided for storing data relating to the operation of the disc drive, the data storage medium being read via the optical means used to read a conventional disc inserted into the disc drive for playback.

This has the advantage of providing an inexpensive additional storage area, without requiring additional space for flash memory within the body of the disc drive.

According to another aspect of the invention, there is provided a method as defined in the appended claims.

For a better understanding of the present invention, and to show more clearly how it may be carried into effect, reference will now be made, by way of example only, to the following drawings in which:

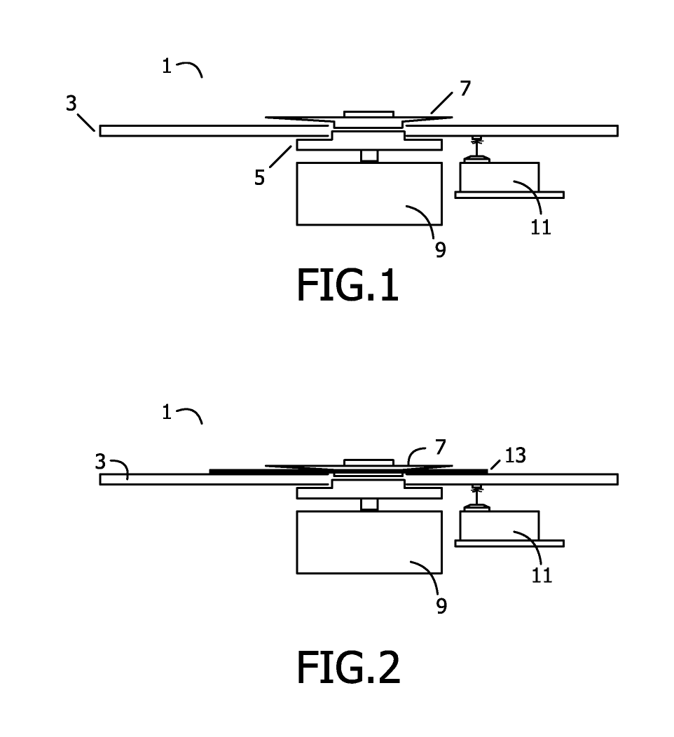

FIG. 1 shows an illustration of a conventional disc drive;

FIG. 2 shows a disc drive according to a first aspect of the present invention;

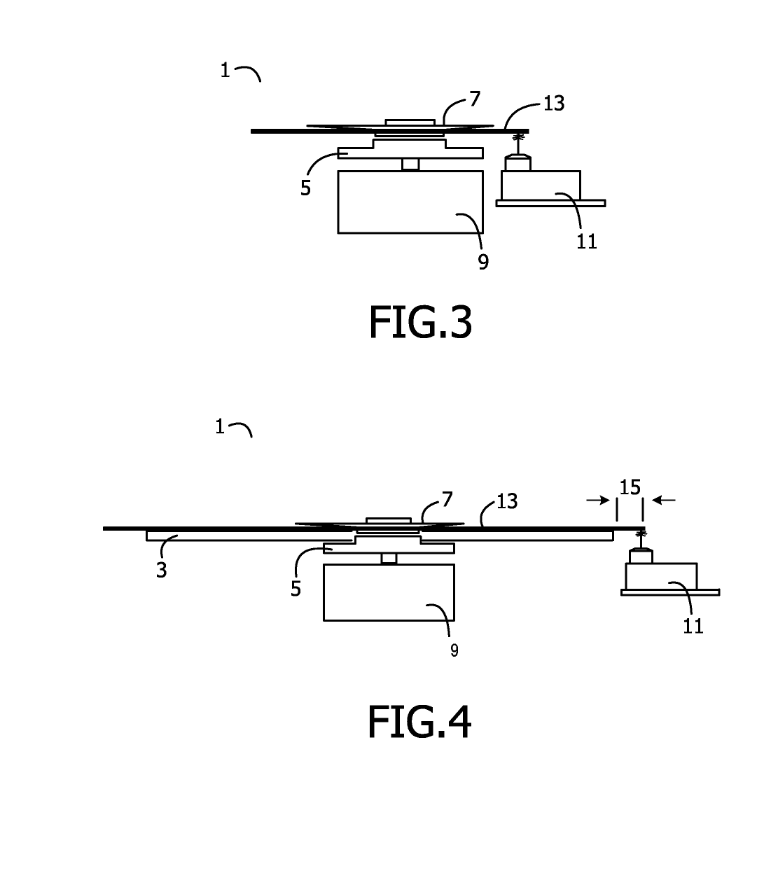

FIG. 3 shows the disc drive of FIG. 2 in operation;

FIG. 4 shows a disc drive according to a second aspect of the present invention; and

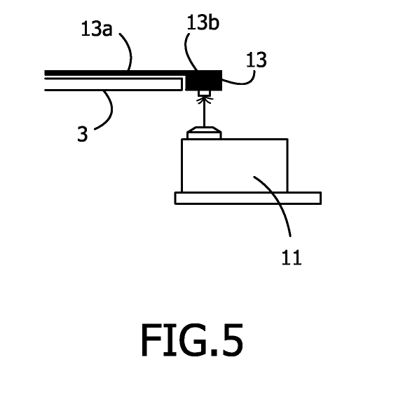

FIG. 5 shows a further aspect of the embodiment of FIG. 4.

FIG. 1 shows a conventional disc drive 1 for writing data to, and/or reading data from, an optical disc 3 that is to be played in the disc drive. The disc drive 1 comprises first clamping means 5 and second clamping means 7 for supporting the optical disc 3 during use. The disc drive 1 also comprises drive means 9, i.e. motor, for rotating the optical disc 3 relative to optical means 11. The optical means 11 are provided for writing data to, and/or reading data from, the optical disc 3.

It will be appreciated that the optical disc 3 can be any form of optical disc, such as CD-R, CD-RW, DVD-R, DVD-RW, +/− and so on.

FIG. 2 shows a disc drive according to a first aspect of the present invention. As with the conventional disc drive of FIG. 1, the disc drive comprises first clamping means 5 and second clamping means 7 for supporting the optical disc 3 during use, and drive means 9 for rotating the optical disc 3 relative to the optical means 11. According to the invention, the disc drive 1 further comprises a data storage medium 13 for storing data such as embedded software for controlling the operation of the disc drive 1. The data storage medium 13 is an optical disc that is fixed or permanently located in the disc drive 1, thereby being permanently available for controlling the operation of the disc drive 1. As mentioned earlier, the storage medium 13 can also be used to store other types of information in addition, or as an alternative, to storing firmware. For example, the storage medium can be used to store keys for copyright protection, disc parameters, executable code, or databases which are permanently needed in the disc drive.

The data storage medium 13 is located coaxially with a normal optical disc 3 that is to be inserted into the disc drive 1 for playback. The data storage medium 13 is also positioned such that, during playback of a normal optical disc 3, the data storage medium 13 is located on the reverse side of the optical disc 3 (i.e. the non-optical side of the optical disc 3, or the side that is away from the optical means 11 during use) such that it does not interfere with normal operation.

In the embodiment of FIG. 2, the data storage medium 13 is radially smaller than a conventional optical disc 3. This means that the data storage medium 13 can only be read before the insertion or after the ejection of a conventional optical disc 3. Since the data storage medium 13 cannot be read while the conventional optical disc 3 is located in the disc drive, the embedded software stored in the data storage medium 13 must be first loaded into RAM within the disc drive 1, prior to inserting the conventional optical disc 3. For example, when the disc drive is powered up, the embedded software stored on the data storage medium 13 is stored in RAM prior to the disc drive operating the loading mechanism for loading a conventional optical disc 3.

The size of the RAM required in the disc drive does not necessarily need to be as large as the data storage capacity of the data storage medium 13. For example, the data storage medium 13 could be configured to store multiple versions of firmware or components, while the whole firmware does not need to be loaded into RAM for operation of the disc drive. Also, if the data storage medium 13 is configured to store only parameters, then these are read directly by the disc drive and do not need to be stored in RAM.

FIG. 3 shows the operation of the disc drive when the conventional optical disc 3 is removed from the disc drive 1, whereby the optical means 11 is able to read data from the data storage medium 13. It will be appreciated that the disc drive preferably has a small amount of internal memory such as ROM or Flash memory in order to boot up the operation of the disc drive for initially reading the data storage medium 13.

FIG. 4 shows a disc drive according to a second aspect of the present invention. As with the conventional disc drive of FIG. 1, the disc drive comprises first clamping means 5 and second clamping means 7 for supporting the optical disc 3 during use, and drive means 9 for rotating the optical disc 3 relative to optical means 11.

As with the first aspect of the invention, the disc drive 1 further comprises a data storage medium 13 for storing data such as embedded software for controlling the operation of the disc drive 1. The data storage medium 13 is permanently located in the disc drive 1, thereby being permanently available for reading data or controlling the operation of the disc drive 1. The data storage medium 13 is located coaxially with a normal optical disc 3 that is inserted into the disc drive 1 for playback. The data storage medium 13 is also positioned such that, during playback of a normal optical disc 3, the data storage medium is located on the other side of the optical disc 3, i.e. the side that is away from the optical means 11, thereby allowing the optical means 11 to read the optical disc 3 without disruption.

However, according to the second aspect of the invention, the data storage medium 13 is radially larger than a conventional optical disc 3. This means that a data storage area 15 is always available for access by the optical means 11, regardless of whether a conventional optical disc 3 is inserted or removed from the disc drive 1. According to this embodiment, data can either be stored just in the outer data storage area 15, or in both the outer data storage area 15 and the inner data storage area that is hidden behind the conventional disc 3 during use.

With the embodiment of FIG. 4, certain types of embedded software can be stored in the area located behind a conventional optical disc 3, thereby being loaded into RAM prior to insertion of a conventional optical disc 3, while other types of embedded software, for example software that must be access during operation of the disc drive, can be stored in the data storage area 15, at the outer region of the data storage medium 13.

The invention has the advantage of providing a data storage medium in a location that has not been previously used to store embedded type software, thereby enabling the conventional memory used for this purpose to be reduced in size, or even eliminated.

FIG. 5 shows a further aspect of the embodiment of FIG. 4, whereby the data storage medium 13 optionally comprises a recess for receiving the optical disc 3 during use. The thickness of the outer region 13b of the data storage medium 13 is greater than the thickness of the inner region 13a of the data storage medium. The recess can therefore assist in retaining the optical disc 3 in position during use, or even remove the need for a separate clamping means 7.

Although the preferred embodiments refer to the data storage medium 13 being permanently located in the disc drive 1, it will be appreciated that the disc drive may be removed in circumstances where the data storage medium becomes damaged and requires replacement, or if the embedded software is to be updated by a new data storage medium containing the new embedded software.

Furthermore, according to another aspect of the invention, the data storage medium can be configured to store data relating to a large number of disc types, with only data relating to the disc type being actually used being uploaded to RAM for controlling the operation of the disc drive. This saves the conventional memory having to store embedded software for all types of optical discs 3. Instead, the data storage medium 13 can store the plurality of control programs, with only the relevant control program being uploaded to RAM for use. It will be appreciated that, with the embodiment of FIG. 2 in which the data storage medium 13 cannot be read while an optical disc 3 is loaded in the disc drive 1, some other means is provided for fore-warning the disc drive of the type of optical disc 3 that is to be loaded, and hence the type of embedded software that needs to be uploaded to RAM.

It is noted that, although the preferred embodiments refer to embedded software being read from the data storage medium 13, it will be appreciated that data can also be written to the data storage medium 13. Preferably, the data storage medium 13 in the embodiments described above comprises at least one recordable or rewritable section. The provision of a rewritable section enables the data stored in the data storage medium to be updated or replaced, for example when it is necessary to encompass access to discs compliant with a standard not known at the time when the disc drive was produced. The data storage medium 13 can either be rewritten in-situ using the optical means 11, or using some other form of device remote from the disc drive itself.

In addition to the use of the invention in the various applications described above relating to the operation and controlling of the disc drive, it is noted that the invention can also be used for other applications, for example relating to the storing/updating of long revocation lists or white lists.

Furthermore, although the first embodiment refers to the data storage medium 13 being positioned on the side of the optical disc 3 that is away from the optical means 11, it will be appreciated that the data storage medium 13 could also be positioned on the other side of the optical disc 3, i.e. the same side as the optical means 11.

Furthermore, although the first embodiment refers to the data storage medium 13 being positioned on the side of the optical disc 3 that is away from the optical means 11, it will be appreciated that the data storage medium 13 could also be positioned on the other side of the optical disc 3, i.e. the same side as the optical means 11.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfill the functions of several units recited in the claims. Any reference signs in the claims shall not be construed so as to limit their scope.

1-12. (canceled)

13. A disc drive comprising:
optical means for writing and/or reading data to and/or from an optical disc that is to be played in the disc drive;
drive means for rotating the optical disc relative to the optical means; and
a data storage medium for storing data relating to the operation of the disc drive, wherein the data storage medium is read via the optical means, the data storage medium being located coaxially with the optical disc, and being positioned such that, during playback of the optical disc, the data storage medium is located to the side of the optical disc that is away from the optical means for writing and/or reading data to and/or from the optical disc, characterized in that
the data storage medium is radially larger than the optical disc and data is stored in an outer region of the data storage medium, the outer region corresponding to the area that is radially larger than the optical disc.

14. A disc drive as claimed in claim 13, wherein data is stored also in an inner region corresponding to the area that is hidden in use by the optical disc being played in the disc drive.

15. A disc drive as claimed in claim 13, wherein the data storage medium comprises a recess for receiving the optical disc during use.

16. A disc drive as claimed in claim 13, wherein the data storage medium is an additional optical disc.

17. A disc drive as claimed in claim 13, wherein the data storage medium is fixed in the disc drive.

18. A disc drive as claimed in claim 13, wherein the data storage medium comprises a rewritable section.

19. A method of operating a disc drive as claimed in claim 13, comprising reading data relating to the operation of the disc drive via the optical means from the outer region of the data storage medium, while the optical disc is inserted in the disc drive.
